(19) United States
(12) Patent Application Publication
(10) Pub. No.: US 2017/0108593 A1
(43) Pub. Date: Apr. 20, 2017

(54) DEVICE FOR DETERMINING THREE DIMENSIONAL LOCATIONS AND ENERGY OF GAMMA INCIDENCE EVENTS AND METHOD FOR THE SAME

(71) Applicant: Institute of Nuclear Energy Research, Atomic Energy Council, Executive Yuan, R.O.C., Taoyuan (TW)

(72) Inventors: Hsin-Chin Liang, Taoyuan County (TW); Hsiang-Ning Wu, Taoyuan (TW); Chung-Yi Chan, Taoyuan (TW)

(21) Appl. No.: 14/989,146

(22) Filed: Jan. 6, 2016

(30) Foreign Application Priority Data
Oct. 20, 2015 (TW) 104134403

(51) Int. Cl. G01T 1/20; G01T 1/202

(52) U.S. Cl. CPC G01T 1/2018; G01T 1/202

(57) ABSTRACT

A method for determining three dimensional locations and energy of gamma incidence events includes the steps of: providing a multi edge-read imaging probe, the multi edge-read imaging probe detecting scintillating photons generated by a gamma incidence event and obtaining a plurality of reaction locations corresponding to the scintillating photons; performing a location-judging process; performing a process for screening valid events; performing an energy-correction process upon the valid events; and, performing a process of energy calculation so as to obtain a total energy value for the gamma incidence event.

### CROSS REFERENCE TO RELATED APPLICATION

This application claims the benefit of Taiwan Patent Application Serial 104134403, filed Oct. 20, 2015, the subject matter of which is incorporated herein by reference.

### BACKGROUND OF INVENTION

1. Field of the Invention

The invention relates to a detecting device for determining locations and energy of gamma incidence events and a method for the same, and more particularly to the device for determining three dimensional locations and energy of gamma incidence events and an accompanying method for the device.

2. Description of the Prior Art

“Nuclear Medicine Imaging Modalities” is one of medical specializations, in which radioactive isotopes are applied to facilitate researches in clinical diagnosis, treatments and diseases. In order to increase ability of locating critical illnesses, such as cancers, for medical specialists to perform early diagnosis and treatment for preventive therapies, researches in nuclear medicine are crucial among national topics to most of major industrial countries in the world.

Theory of Nuclear medicine is mainly to capture information of locations and distribution of radioactive energy (in gamma ray, γ-ray, for example) radiated from specific radiopharmaceutical medicines absorbed by the body tissues by having an imaging probe to detect information of locations and energy of gamma incidence. The information thereof is then processed and iteratively reconstructed to obtain image of medicine distribution in the body tissues. Such an image can be useful for the medical specialists to make clinical diagnosis and judgment. In the art, methods to capture image of body tissues can be generally classified into two categories: the positron emission tomography (PET) and the single-photon emission computed tomography (SPECT); both of which need a gamma imaging probe for providing information of locations and energy to calculate the distribution image of the radiopharmaceutical medicines in the tissues. As shown in FIG. 1, the theory of the PET is schematically demonstrated. Generally, the PET is an imaging tool to detect the γ-ray pair generated in annihilation of the positron 80 and the electron 81. The isotope emitted by the positron such as F-18, C-11, N-13 and O-15 are tagged onto the medicine, then the medicine is sent into the body by injection or the like, and finally the medicine precisely reaches the tissue to be tested inside the body through various physiological actions. After the medicine reaches the tissue to be tested, the non-destructive imaging of the tissue can be obtained by tracking the metabolism of the radiopharmaceutical medicine. Currently, the PET is widely applied for clinical diagnosis upon the cancers, nervous lesions, cardiovascular diseases, and so on.

Referring now to FIG. 2A, a schematic view of a conventional PET apparatus is illustrated. The PET apparatus 1 mainly includes a plurality of sensing arrays 10 formed in a circular permutation. A detection area 11 is formed in the middle of the circular permutation for allowing the tissue to be tested to be sent through for a testing purpose. Each of the sensing arrays 10, i.e. the imaging probe, is structured as the conventional imaging detector shown in FIG. 2B. Basically, the sensing array 10 is mainly consisted of a plurality of scintillating crystals such as the lutetium oxyorthosilicate (LSO). The scintillating crystal array 100 and the photon sensing array 101 formed by, for example, a plurality of photomultiplier tube (PMT) are engaged at one side of the scintillating crystal array 100. The conventional imaging detector described herein is structured as an oriented configuration, which is adopted by majority of the current systems in the merchandise market.

In the art, the gamma rays reach the scintillating crystal arrays 102, 103, 104 at the tops thereof, as shown in FIG. 2C. The incident gamma rays react with the crystal molecules and leave energy to the molecules. After experiencing a series of transformation and degrading actions inside the crystals, a substantial amount of scintillating photons are emitted from bottoms of the scintillating crystal arrays 102, 103, 104. These scintillating photons are then led to hit the photon sensing arrays, and corresponding photoelectric transformation occurs in the photon sensing arrays. After some following specific treatments upon the electric signals, positrons of the crystals in reaction with the incidence gamma rays can be precisely detected. Also, after a certain period of time to accumulate signals, a two dimensional image can be configured substantially similar to the distribution of the scintillating crystal arrays. Such an image is the basic tool for reconstructing the distribution image of the injected radiopharmaceutical medicines. Nevertheless, at the current imaging detector applying the foregoing technique, when the angle of incidence of the gamma ray increases, some incident rays are highly possible to penetrate the first-arrival crystal and reach the second-arrival crystal where the scintillating reaction occurs, due to high energy of the gamma ray and tiny sizes of the crystals. As shown in FIG. 2C, for the gamma ray with an angle of incidence θ₁, a difference between the practical detected crystal location at 103 and the ideal incidence crystal location at 102 exists by a crystal unit. For the gamma ray with a larger angle of incidence θ₂, the difference between the practical detected crystal location at 104 and the ideal incidence crystal location at 102 grows to two crystal units. Such a difference is usually deemed as a parallax error, which would eventually lead to quality down in imaging.

Referring now to FIG. 3, a conventional dual edge-read imaging detector is schematically shown. By applying a plurality of dual edge-read imaging detectors 12 of FIG. 3, the circular-permutation PET apparatus of FIG. 2A can also be formed. Compared to the imaging detector of FIG. 2B, the dual edge-read imaging detector 12 of FIG. 3 is mainly to construct two photon sensing arrays (PSA) 121, 123 to the rear and front ends of the crystal array 120 consisted of a plurality of scintillating crystals, respectively. The incident γ-ray 122 introduced to the crystal array 120 would react with a specific crystal 124 so as to generate corresponding scintillating photons. Since the generation of photons is uniform and the surface of the crystal is usually treated by anti-glaring, the scintillating photons 125, 126 generated would go along two opposing long axes of the photon-detecting array. During the photon transmission, the scintillating photons would decay due to the absorption action by the crystal itself. Anyway, the photons would be detected finally by the photon-detecting arrays 121, 123 located at both ends of the scintillating crystal 124. Since the detecting crystal array 120 is a two dimensional array, thus the 2-dimensional coordinate (y, z) of the origin to generate the scintillating photons would be obtained by proper signal processes. However, in this kind of the conventional imaging detector, a third coordinate (x) for the origin can't be calculated.

In a Taiwan Patent I356689 and a U.S. Pat. No. 8,507,842 B2, an energy correction process is proposed to utilize the decay phenomenon of the scintillating photons travelling along the crystal so as to establish energy windows and expected photopeak positions for obtaining a more-precise energy ratio after the photons decay, such that a third-dimensional coordinate at the X-axis can be obtained. However, in these two teachings, if the sampled energy values at the same scintillating photons are biased already to a substantial degree, the calculated X-axial coordinate would be deviated from the accurate position due to computational error propagations. In addition, for the gamma energy information required for imaging, the aforesaid two disclosures provide no solution for the structural decay of the energy value.

In another U.S. Pat. No. 8,183,533, a shared window pattern is applied to every detecting crystal arrays along a Z direction. However, in this teaching, the accumulating calculated error along the Z-axis is still existed. In addition, since individual shared window patterns are established for neighboring layers of the detecting crystals, larger computational errors in both X and Y directions can be expected due to the energy sharing. Further, since the establishment of the disclosed shared window pattern is structurally complicated, so difficulty in embodying is inevitable.

### SUMMARY OF THE INVENTION

Accordingly, it is the primary object of the present invention to provide a simpler but more accurate method for determining three dimensional locations and energy of gamma incidence events. Unlike the prior art that applies the energy ratios to estimate the coordinates, the instant method can use a less-complicated but more-precise approach to obtain three dimensional coordinates, and further thereby to calculate corresponding energy correction coefficients for correcting the aforesaid phenomenon of energy bias. Hence, a more precise gamma energy value in the testing can be obtained.

In the present invention, a device for determining three dimensional locations and energy of gamma incidence events is an improvement of the detector structure by separating each layer of the detecting crystals into two laminated arrays. These two laminated detecting crystal arrays are conductive in a Z direction, and it is still light-isolated from layer to layer. Photon sensing arrays (PSA) are mounted to surround the detecting crystals. Upon such an arrangement, the method for determining three dimensional locations and energy of gamma incidence events of the present invention is implemented to obtain simpler and more precisely three dimensional location values. Further, based on the location values and correction coefficients of energy values, the bias phenomenon in energy detection can be significantly reduced so as to better realize the gamma energy value.

In the present invention, the method for determining three dimensional locations and energy of gamma incidence events comprises the steps of: (1) providing a multi edge-read imaging probe; (2) the multi edge-read imaging probe detecting scintillating photons generated by a gamma incidence event, and thus obtaining a plurality of reaction locations corresponding to the scintillating photons; (3) performing a location-judging process, a correction process being applied to determine crystal look-up tables corresponding to the plurality of reaction locations, three dimensional locations respective to the plurality of reaction locations of the gamma incidence event being obtained by referring to the crystal look-up tables; (4) performing a process for screening a valid event, comparing location values of the plurality of reaction locations, the gamma incidence event being defined as a valid event and three dimensional location values being confirmed if the comparing of the location values is coherent; (5) performing an energy-correction process upon the valid event, obtaining correction coefficients of energy values respective to the photon sensing arrays by comparing the energy-correction coefficient tables determined by the correction process and according to the three dimensional location values of the valid event; and, (6) performing a process of energy calculation, multiplying and summing the energy values with the respective correction coefficients for the corresponding photon sensing arrays of the valid event so as to obtain a total energy value for the gamma incidence event.

In one embodiment of the present invention, prior to the step (1), the method further includes the steps of: (a) having a uniform emitting source to expose the multi edge-read imaging probe so as to accumulate a large amount of data of the gamma incidence events, recording a plurality of weight signals from each of the gamma incidence events; and, (b) obtaining a corresponding weighting center by calculating four of the weight signals of each of the photon sensing arrays for each of the gamma incidence events so as further to obtain a corresponding reaction location respective to each of the photon sensing arrays.

In one embodiment of the present invention, after the step (b), the method further includes the steps of: (c) based on the photon sensing arrays, forming corresponding histograms from the reaction locations of the gamma incidence events so as to establish corresponding crystal maps to the individual photon sensing arrays; and, (d) analyzing individually the crystal maps so as to establish corresponding crystal look-up tables with respect to the individual photon sensing arrays.

In one embodiment of the present invention, after the step (d), the method further includes the steps of: (e) basing on the crystal look-up tables of the corresponding photon sensing arrays to obtain location codes of the individual gamma incidence events; (f) screening valid events; and, (g) based on the three dimensional location values, further classified the four energy values for each of the photon sensing arrays of each of the valid events by the photon sensing arrays, accumulating the energy values to obtain four energy spectrums of each of the location values corresponding to the individual photon sensing arrays.

In one embodiment of the present invention, after the step (g), the method further includes the steps of: (h) analyzing the four energy spectrums of each of the location values to obtain photo-peak channels corresponding to the individual energy spectrums, further having the location values as entries for four photo-peak tables corresponding to the four photon sensing arrays; (i) selecting basic correction values of energy individually from the corresponding photo-peak tables; and, (j) obtaining energy-correction coefficient tables for the corresponding photon sensing arrays.

In one embodiment of the present invention, the method further includes a step of performing a pre-correction process upon the multi edge-read imaging probe.

In the present invention, the device for determining three dimensional locations and energy of gamma incidence events comprises at least one multi edge-read imaging probe, each of the at least one multi edge-read imaging probe having a plurality of multi edge-read imaging detectors. Each of the multi edge-read imaging detectors further has: a detecting crystal array, including a plurality of detecting crystal layers, each of the detecting crystal layers having a first-row detecting crystal and a second-row detecting crystal, the first-row detecting crystal being arranged perpendicular to the second-row detecting crystal, the first-row detecting crystals being individually isolated in a light-spaced pattern, the second-row detecting crystals being individually isolated in a light-spaced pattern, contact surfaces between the first-row detecting crystals and the neighboring second-row detecting crystals being light-conductive, a light-spaced pattern being applied in the contact surfaces between layers; and, a plurality of photon sensing arrays arranged individually to four lateral sides of the detecting crystal array, respectively, so as to detect the scintillating photons reaction inside the detecting crystal array; wherein, based on a plurality of reaction locations of each of the photon sensing arrays and compared with crystal look-up tables of the corresponding photon sensing arrays, location values with respect to the individual photon sensing arrays are obtained; wherein a screen process is performed to determine valid events and corresponding three dimensional location values; wherein the location values are used to obtain correction coefficients of energy values with respect to the individual photon sensing arrays; wherein accurate energy of the gamma incidence event is calculated by multiplying and summing the correction coefficients and the energy values of the individual photon sensing arrays.

All these objects are achieved by the device for determining three dimensional locations and energy of gamma incidence events and the method for the same described below.

### BRIEF DESCRIPTION OF THE DRAWINGS

The present invention will now be specified with reference to its preferred embodiment illustrated in the drawings, in which:

FIG. 1 demonstrates schematically the theory of the positron emission tomography (PET);

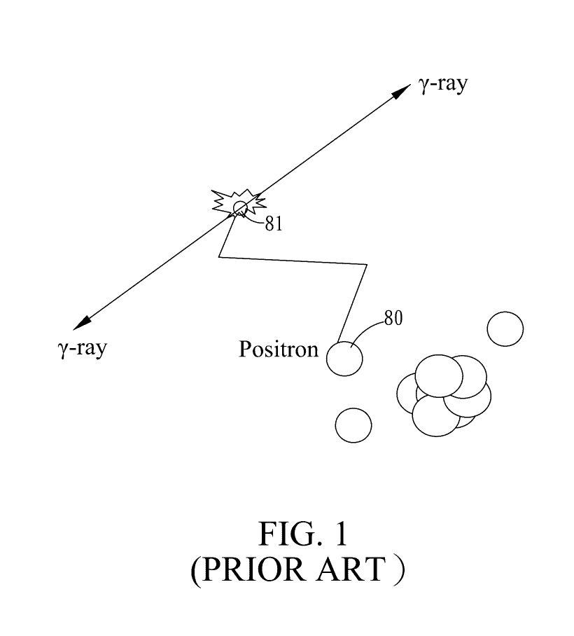

FIG. 2A is a schematic view of a conventional PET apparatus;

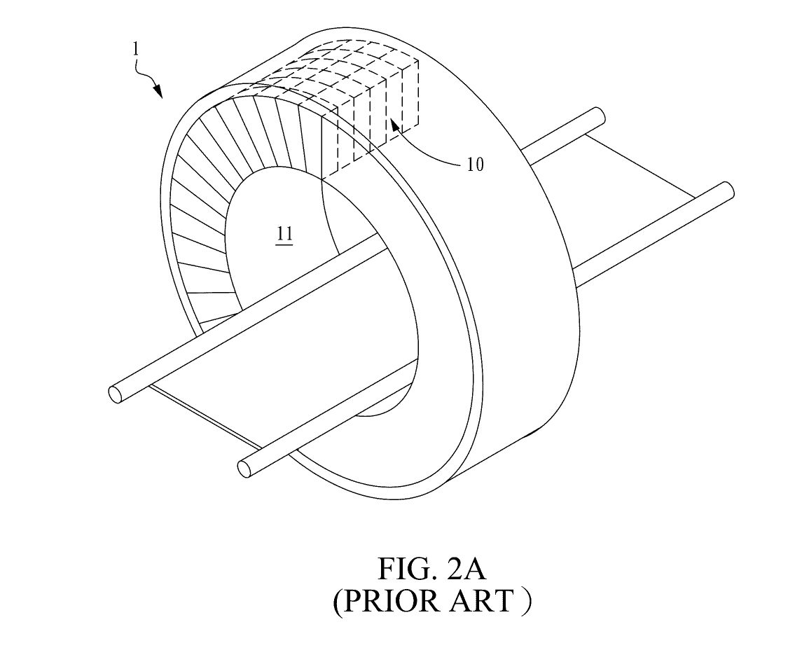

FIG. 2B shows schematically a conventional imaging detector for the conventional PET apparatus of FIG. 2A;

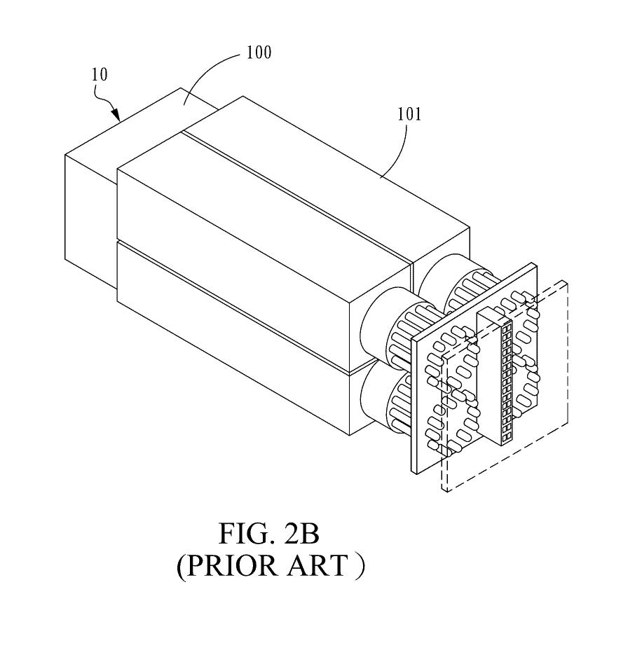

FIG. 2C demonstrates schematically the incidence of gamma rays to the crystal units, showing the parallax error;

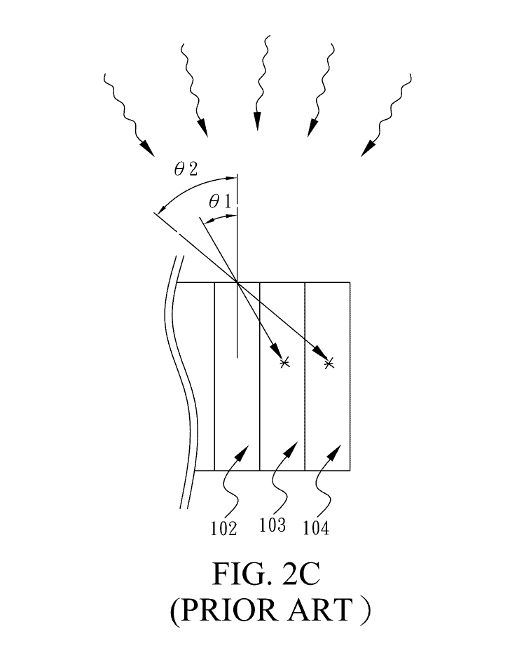

FIG. 3 is a schematic view of a conventional dual edge-read imaging detector;

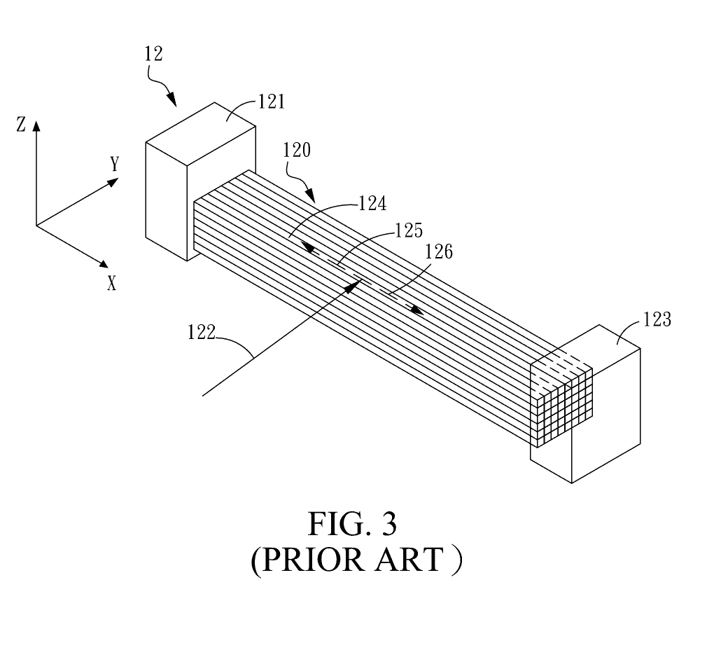

FIG. 4 is a flowchart of a preferred for determining three dimensional locations and energy of gamma incidence events in accordance with the present invention;

FIG. 5A is a schematic top view of a preferred multi edge-read imaging probe in accordance with the present invention;

FIG. 5B is a lateral side view of FIG. 5A;

FIG. 6 is a flowchart of a preferred location-correction process in accordance with the present invention;

FIG. 7 is a flowchart of a preferred energy-correction process in accordance with the present invention;

FIG. 8A is a gamma energy plot for a testing sample in accordance with the present invention; and

FIG. 8B is a gamma energy plot for another testing sample in accordance with the present invention.

### DESCRIPTION OF THE PREFERRED EMBODIMENT

The invention disclosed herein is directed to a device for determining three dimensional locations and energy of gamma incidence events and a method for the same. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

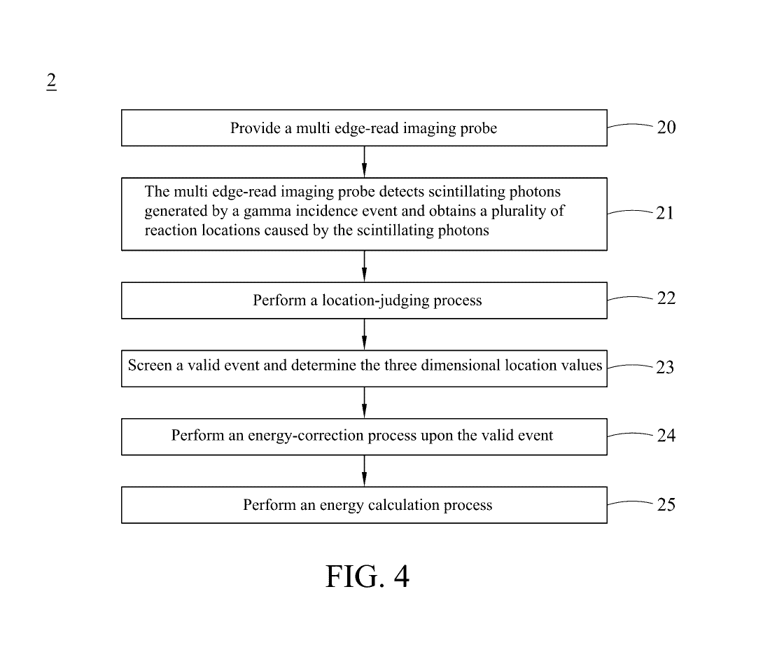

Referring now to FIG. 4, a flowchart of a preferred method for determining three dimensional locations and energy of gamma incidence events in accordance with the present invention is shown. In this embodiment, the method for determining three dimensional locations and energy of gamma incidence events 2 includes the following Steps 20˜25. Prior to performing the method for determining three dimensional locations and energy of gamma incidence events 2, a correction process upon a multi edge-read imaging detector 3 would be performed in advance in Step 19.

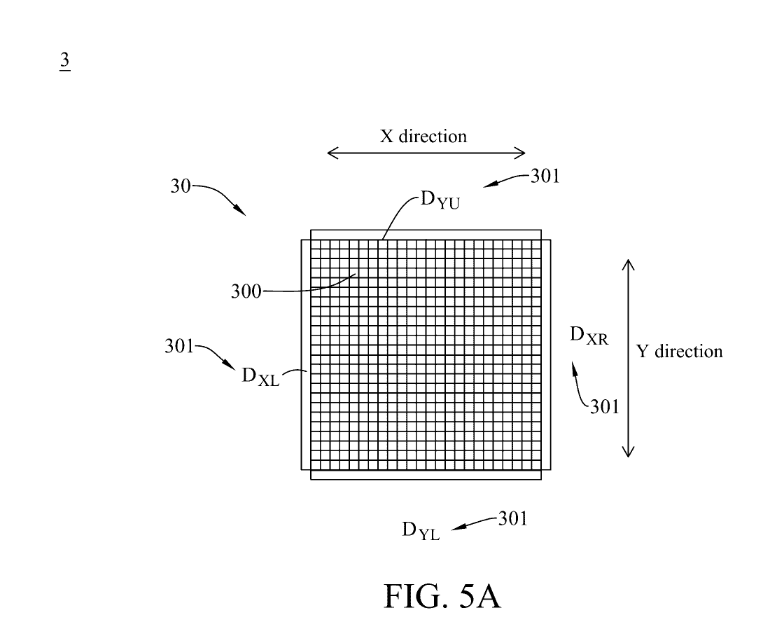

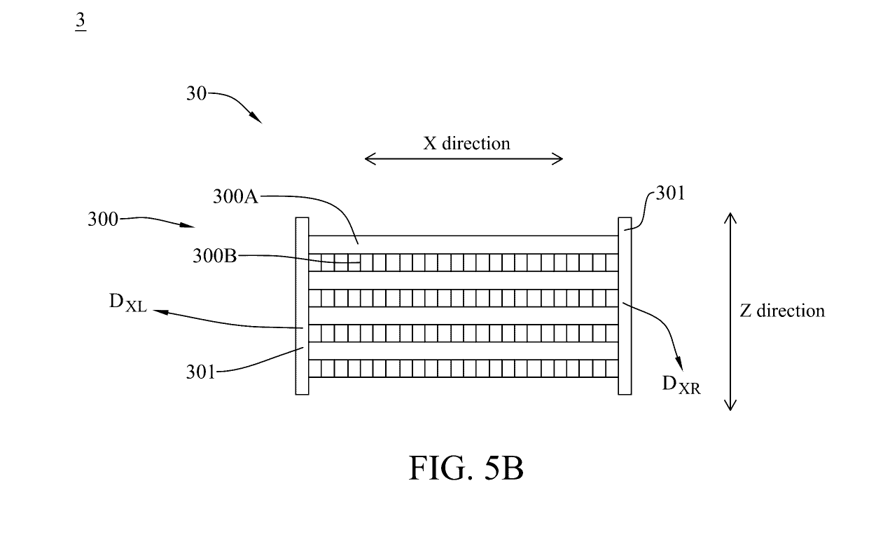

The multi edge-read imaging probe 3 as shown in FIG. 5A and FIG. 5B includes a plurality of multi edge-read imaging detectors 30 (for a concise explanation purpose, a single multi edge-read imaging detector 30 is plotted only in the figure). The multi edge-read imaging detectors 30 are arranged orderly into a detection plane. Each of the multi edge-read imaging detectors 30 has a detecting crystal array 300 and four photon sensing arrays (PSA) 301.

The detecting crystal array 300 is in a matrix form consisted of a plurality of slender (length/cross section area>10) detecting crystals, in which each detecting crystal of the detecting crystal array 300 is a scintillating crystal, made of a solid-state scintillating material including (but not limited to) LSO, LYSO, NaI, CWO, SrI₂, GSO(Z), CeBr₃, LaCl₃ and LaBr₃.

The detecting crystal array 300 includes a plurality of layers of detecting crystals. By having the typical arrangement shown in FIG. 5A and FIG. 5B, there are four layers of detecting crystals arranged along the Z axis, and each layer has 24 detecting crystals arranged along the X axis and 24 detecting crystals arranged along the Y axis. It shall be noted that every two neighboring layers of the detecting crystals are spaced for allowing light rays to pass therebetween (defined as a light-spaced pattern) in the Z axis.

By viewing in the Z direction, each layer of the detecting crystals has first-row detecting crystals 300A and second-row detecting crystals 300B, in which the first-row detecting crystals 300A are arranged orderly along the Y axis, while the second-row detecting crystals 300B are arranged orderly along the X axis. Namely, in this embodiment, by cutting the multi edge-read imaging detectors 30 into halves along the Z axis, it is shown that the first-row detecting crystals 300A and the second-row detecting crystals 300B are arranged in a perpendicular manner, the first-row detecting crystals 300A are individually isolated in a light-spaced pattern in the Y direction, and also the second-row detecting crystals 300B are individually isolated in a light-spaced pattern in the X direction. Further, the contact surface between the first-row detecting crystals 300A and the neighboring second-row detecting crystals 300B are light-conductive.

In addition, four photon sensing arrays 301 are arranged individually to four lateral sides of the detecting crystal array 300, respectively, so as to detect the scintillating photons reaction inside the detecting crystal array 300. Namely, two of the four photon sensing arrays 301 are mounted to two opposing ends of the detecting crystal array 300 in the X direction (labeled as D_{XL} and D_{XR}), and the other two thereof 301 are mounted to another two opposing ends of the detecting crystal array 300 in the Y direction (labeled as D_{YU} and D_{YL}). Upon such an arrangement, energy of the scintillating photons generated inside the detecting crystal array 300 at any direction can be detected. In this present invention, the photon sensing array 301 can be selected from the group of a PMT array, a PS-PMT detector/array, a PS-SiPM detector/array, a PS-APD detector/array and an SiPM array.

To complete the aforesaid arrangement for the multi edge-read imaging probe 3, a pre-correction process is necessarily performed to the multi edge-read imaging probe 3. In this embodiment, a gain-uniform correction for the four photon sensing arrays is firstly carried out, in a correlated manner, to the four photon sensing arrays D_{XL}, D_{XR}, D_{YU} and D_{YL}. Inside each of the photon sensing arrays D_{XL}, D_{XR}, D_{YU} and D_{YL}, a signal-readout electronics with a linear weighting circuit structure is included for the respective photon sensing arrays D_{XL}, D_{XR}, D_{YU} and D_{YL} able to output signals in both opposing directions (for example, the XZ direction or the YZ direction). Preferably, each of the said direction can have two weight signals. Namely, each of the four photon sensing arrays D_{XL}, D_{XR}, D_{YU} and D_{YL} can output four weight signals for following calculation in locations and energy.

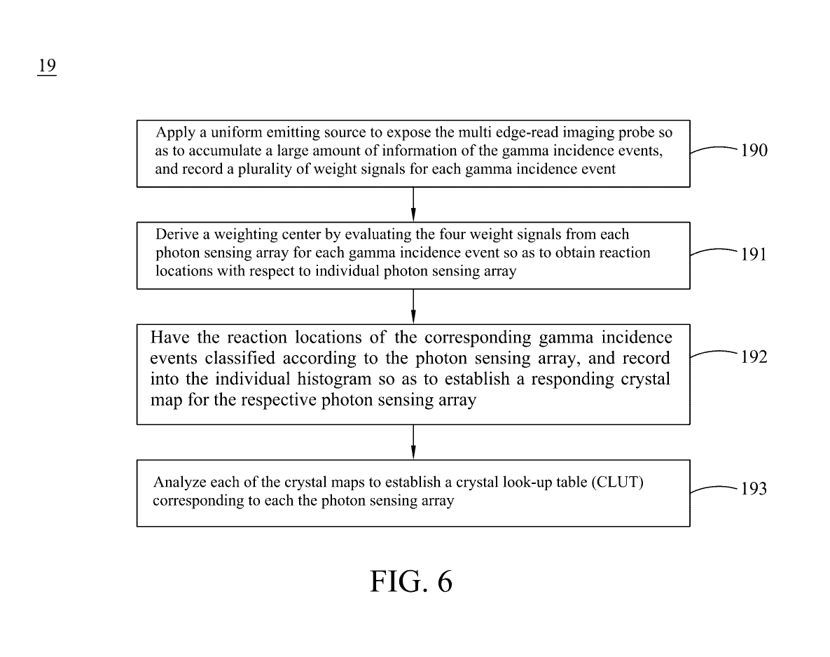

After the multi edge-read imaging probe 3 performs the pre-correction process, then a location-correction process is performed. Referring to FIG. 6, a flowchart of a preferred location-correction process in accordance with the present invention is shown. In practice, in performing Step 190, a uniform emitting source is applied to expose the multi edge-read imaging probe 3 so as to accumulate a large amount of information of the gamma incidence events; in particular, by recording a plurality of weight signals for each gamma incidence event. Then, in performing Step 191, a weighting center is derived by evaluating the weight signals from each of the four photon sensing arrays for each individual gamma incidence event, such that the reaction location with respect to the four individual photon sensing arrays can be obtained by processing the weight signals. Namely, the weighting center is obtained by calculating corresponding weight signals respective to the four photon sensing arrays D_{XL}, D_{XR}, D_{YU} and D_{YL}, and the reaction location for the four photon sensing arrays D_{XL}, D_{XR}, D_{YU} and D_{YL} can thus be determined by the weighting center.

In this embodiment, the first-row detecting crystals 300A and the second-row detecting crystals 300B are communicative to each other. Hence, a portion of scintillating photons generated by reacting a specific one of the first-row detecting crystals 300A with the incident gamma ray would travel along a long axis of the incident detecting crystal 300A of the first-row detecting crystals 300A and toward the opposing photon-detecting arrays D_{XL} and D_{XR}, while another portion thereof enters the second-row detecting crystal 300B neighboring the first-row detecting crystal 300A, travels along a long axis of the incident detecting crystal 300B of the second-row detecting crystals 300B, and towards the opposing photon sensing arrays D_{YU} and D_{YL}.

Accordingly, since the structuring of the detecting crystal arrays 300, a larger amount of output signals (the scintillating photons) would be generated at the point of the light source, i.e. the gamma-incidence reaction point. Thus, while in computing the location, each of the gamma incidence events can trigger all four photon sensing arrays D_{XL}, D_{XR}, D_{YU} and D_{YL} to generate respective weight signals. Namely, each of the gamma incidence events would lead to generation of weight signals at the photon sensing arrays D_{XL} and D_{XR} in the X direction and at the photon sensing array D_{YU} and D_{YL} in the Y direction. Each of the four photon sensing arrays D_{XL}, D_{XR}, D_{YU} and D_{YL} can provide a set of corresponding weight signals. The four weight signals of this set of the photon sensing arrays D_{XL}, D_{XR}, D_{YU} and D_{YL} are to be processed for producing a corresponding weighting center. Upon such an arrangement, the reaction location for this current set of the photon sensing arrays D_{XL}, D_{XR}, D_{YU} and D_{YL} can be derived.

Then, in performing Step 192, all the derived reaction locations of the corresponding gamma incidence events belong to the same photon sensing arrays are recorded into the individual histogram so as to establish a responding crystal map for the respective photon sensing array. In this embodiment, the histogram is established by including reaction locations for each set of the photon sensing arrays D_{XL}, D_{XR}, D_{YU} and D_{YL}, and the crystal map respective to each set of the photon sensing arrays D_{XL}, D_{XR}, D_{YU} and D_{YL} related to the gamma incidence events is thus determined.

Then, in performing Step 193, each of the crystal maps is analyzed so as to establish a crystal look-up table (CLUT) corresponding to each the photon sensing array. In this embodiment, the crystal look-up tables respective to the four photon sensing arrays D_{XL}, D_{XR}, D_{YU} and D_{YL} are obtained by analyzing the four crystal maps corresponding to the four photon sensing arrays D_{XL}, D_{XR}, D_{YU} and D_{YL}

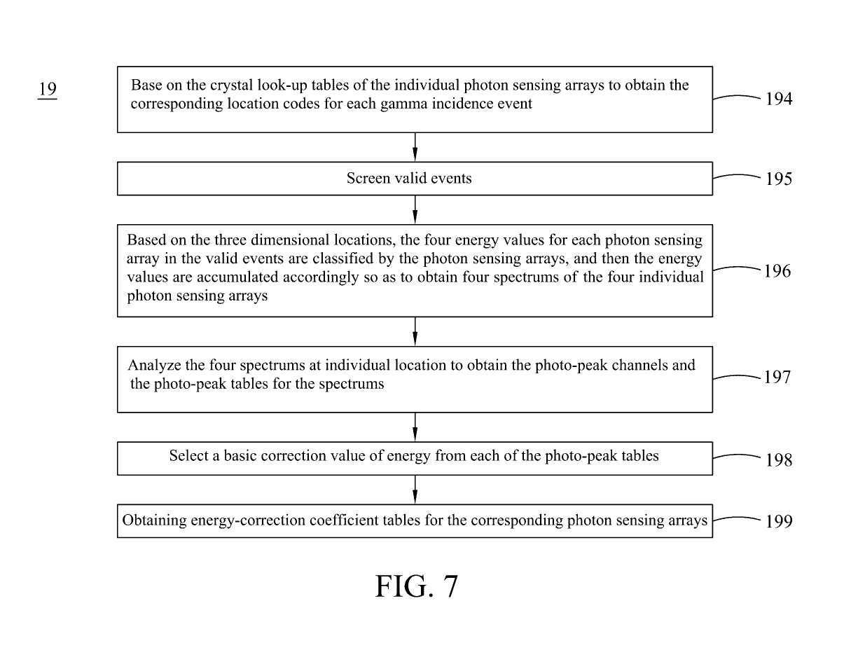

In addition, regarding the energy computation, refer to FIG. 7, a flowchart of a preferred energy-correction process in accordance with the present invention is shown.

In Step 194, based on the crystal look-up tables of the individual photon sensing arrays, the corresponding location codes for each gamma incidence event can be obtained. In this embodiment, apply the crystal look-up tables for the corresponding photon sensing arrays D_{XL}, D_{XR}, D_{YU} and D_{YL} in Step 193 to obtain the respective location codes (Y, Z)_{XL}, (Y, Z)_{XR}, (X, Z)_{YU} and (X, Z)_{YL}; in which the X is the coordinate value for the corresponding event location from photon sensing arrays in the X direction, the Y is the coordinate value for the corresponding event location from photon sensing arrays in the Y direction, and the Z is the coordinate value for the corresponding event location from all the photon sensing arrays.

In Step 195, a step of screening valid events is performed.

In this embodiment, check if all the Z values of the four photon sensing arrays D_{XL}, D_{XR}, D_{YU} and D_{YL} are the same or not. If the three-dimensional coordinate values (i.e. the coordinates (X, Y, Z)) for the four photon sensing arrays D_{XL}, D_{XR}, D_{YU} and D_{YL} are the same, then the computation of the location for the gamma incidence event is said to be complete, and thus this incidence event is deemed as a valid event.

Contrarily, if a single coordinate value in any arbitrary direction for the reaction location is different to the other three, then a comparison upon energy values at the reaction locations of the event is further performed so as to judge if the event is valid or not.

In this embodiment, if the four Z values of the four photon sensing arrays D_{XL}, D_{XR}, D_{YU} and D_{YL} are not completely identical, then the event is deemed as invalid and thus omitted.

Further, if the Y values of the photon sensing arrays D_{XL} and D_{XR} are not completely identical, then check energy values at the reaction locations for the photon sensing arrays D_{XL} and D_{XR}. It shall be understood that the so-called energy value herein is to indicate the individual sum of the four weight signals for each of the photon sensing arrays D_{XL}, D_{XR}, D_{YU} and D_{YL}.

For example, check if or not the larger energy value of the photon sensing array D_{XL} and the photon sensing array D_{XR} is twice more than a smaller energy value of thereof. If positive, then the X value of the larger energy value is defined as the X value for the screened valid event, while the Y value of the smaller one is omitted. Similarly, if the X values (coordinate values in X direction) for the photon sensing arrays D_{YU} and D_{YL} are not completely identical, then the Y value for the screened valid event can also be determined.

The location values of the valid events screened by the process of Step 195 can thus be provided as basic data for carrying on the following energy correction.

Then, in Step 196, based on the three dimensional locations, the four energy values for each set of the photon sensing arrays in the valid events are further classified by the photon sensing arrays, and then the energy values are accumulated accordingly so as to obtain four spectrums of each of the coordinates corresponding to the individual photon sensing arrays.

In this embodiment, by having the location codes (i.e. X, Y, Z) as the box units to accumulate energy values of the location codes for corresponding photon sensing arrays D_{XL}, D_{XR}, D_{YU} and D_{YL}, then the spectrum distributions for different locations for respective photon sensing arrays D_{XL}, D_{XR}, D_{YU} and D_{YL} can thus be obtained.

Then, in Step 197, by analyzing the four spectrum distributions at individual location, the photo-peak channel for the spectrum distributions can be obtained. Further, by having the location values as the indexes to form corresponding tables, then four photo-peak tables for the four photon sensing arrays can thus be obtained.

In this embodiment, after analyzing the spectrum distributions at different reaction locations for individual photon sensing arrays D_{XL}, D_{XR}, D_{YU} and D_{YL} so as to obtain the corresponding photo-peak channel, then the location codes deemed as indexes for tables are applied to obtain the four photo-peak tables for the four photon sensing arrays D_{XL}, D_{XR}, D_{YU} and D_{YL} at the individual reaction locations.

Thereafter, in Step 198, select a basic correction value of energy from each of the photo-peak tables.

In this embodiment, the maximal values in the individual photo-peak tables for the four photon sensing arrays D_{XL}, D_{XR}, D_{YU} and D_{YL} are selected as the basic correction values.

In Step 199, a step of obtaining energy-correction coefficient tables for the corresponding photon sensing arrays is performed.

In this embodiment, by dividing the basic correction value to each entry of the photo-peak tables for the four photon sensing arrays D_{XL}, D_{XR}, D_{YU} and D_{YL}, then energy-correction coefficient tables for the four photon sensing arrays D_{XL}, D_{XR}, D_{YU} and D_{YL} at individual reaction locations can thus be established. In the following usage, the decayed-to-biased energy values would be corrected so as thereby to obtain accurate gamma incidence energy.

After performing the correction process in Step 19, Step 20 can thus be finished to provide a normal operable multi edge-read imaging probe 3.

In Step 21, the multi edge-read imaging probe 3 detects scintillating photons generated by a gamma incidence event and thereby obtains a plurality of reaction locations caused by these scintillating photons.

In this embodiment, while the multi edge-read imaging probe 3 is exposed to gamma rays from an object to be imaged, the multi edge-read imaging probe 3 can then capture the out-going gamma rays from the object. The object emits gamma rays to the multi edge-read imaging probe 3 can provide a large amount of data for imaging from these gamma incidence events, preferably in three dimension locations and energy values, for following computations in imaging.

Each of the gamma incidence events can trigger four photon sensing arrays D_{XL}, D_{XR}, D_{YU} and D_{YL}. Namely, each gamma incidence event can induce weight signals from the photon sensing arrays D_{XL} and D_{XR} in the X direction and also from the photon sensing arrays D_{YU} and D_{YL} in the Y direction. Each of the photon sensing arrays D_{XL}, D_{XR}, D_{YU} and D_{YL} can respond to issue four weight signals for a single gamma incidence event. Every four weight signals of the individual photon sensing arrays D_{XL}, D_{XR}, D_{YU} and D_{YL} are used to compute the corresponding weighting center, and so as further to obtain the reaction location respective to the crystal map of each the photon sensing array D_{XL}, D_{XR}, D_{YU} or D_{YL}.

In Step 22, a location-judging process is performed. By applying the crystal look-up table obtained in the correction process (Step 19) and the plurality of the reaction locations, the corresponding three dimensional location coordinates for these reaction locations in each gamma incidence event can thus be realized.

In this embodiment, by applying the crystal look-up tables for the corresponding photon sensing arrays D_{XL}, D_{XR}, D_{YU} and D_{YL} determined in the correction process (Step 193), the respective location codes (Y, Z)_{XL}, (Y, Z)_{XR}, (X, Z)_{YU} and (X, Z)_{YL} can be obtained, and further the three dimensional locations related to the plurality of the reaction locations with respect to each of the photon sensing arrays D_{XL}, D_{XR}, D_{YU} and D_{YL} can thus obtained; in which the X is the coordinate value for the corresponding event location from photon sensing arrays in the X direction, the Y is the coordinate value for the corresponding event location from photon sensing arrays in the Y direction, and the Z is the coordinate value for the corresponding event location from all the photon sensing arrays.

In Step 23, a process of screening a valid event is performed. In this process, surveying a plurality of location codes/values is carried out. If the comparison of the coordinates/locations is coherent, then the instant event is a valid event, and the corresponding three dimensional location (coordinate values) is recorded. Otherwise, an invalid event is met, and no record is made.

In this embodiment, check firstly if or not the Z values for the four photon sensing arrays D_{XL}, D_{XR}, D_{YU} and D_{YL} are the same. If positive, then check the X coordinate values and the Y coordinate values. Otherwise, the event is defined as an invalid event and is discarded.

If the X and Y coordinate values are both the same, then the process of screening a valid event is complete. Otherwise, if the X or Y coordinate values are not the same in a specific direction, then compare the energy values at the opposing ends of the photon sensing array at that specific direction, and the energy value is an important reference for screening valid events and confirming the locations.

Furthermore, if the Y values (coordinate values in the Y direction) of the photon sensing arrays D_{XL} and D_{XR} are not completely identical, then check the energy values of the photon sensing arrays D_{XL} and D_{XR}. It shall be noted is that the so-called energy value for a specific photon sensing array herein is the sum of the weight signals of that specific photon sensing array.

For example, check if the larger (energy) value of the photon sensing arrays D_{XL} and the photon sensing array D_{XR} is twice more than the smaller value of the photon sensing arrays D_{XL} and the photon sensing array D_{XR}. If positive, the Y value corresponding to the larger energy value is defined as the Y value for the screened valid event, and the smaller is neglected. If negative, then the instant event is deemed as invalid and thus discarded. Similarly, if the X values (coordinate values in the X direction) of the photon sensing arrays D_{YU} and D_{YL} are not completely identical, then the same screen criteria are applied to define the X value for the photon sensing arrays D_{YU} and D_{YL} of the valid event, and to discard the event if invalid.

In Step 24, an energy-correction process is performed upon the valid events. Compared to the energy-correction coefficient tables established in the correction process (Step 199), and based on three dimensional location values of the valid events, correction coefficients of the energy values with respect to the individual photon sensing arrays can thus be obtained.

In Step 25, a process of energy calculation is performed. The process multiples the energy value with the respective correction coefficient for each photon sensing array of the valid event, and then add together all the foregoing multipliers of all four photon sensing arrays so as to obtain an accurate total energy value for this valid gamma incidence event.

Namely, the energy value of a specific photon sensing array D_{XL}, D_{XR}, D_{YU} or D_{YL} is firstly multiplied by the corresponding correction coefficient of the energy value so as to form a number for this specific photon sensing array. Then, the numbers of all four photon sensing arrays D_{XL}, D_{XR}, D_{YU} and D_{YL} are added together so as to form the total energy value for this valid gamma incidence event. In this embodiment, according to a comparison between the plural reaction locations of the individual photon sensing arrays and the crystal look-up tables of the respective photon sensing arrays, then location value of each individual photon sensing array can be obtained. After further screening, valid or invalid for the instant event can be determined, and the three dimensional location value for the valid event can then determined. In addition, based on the correction coefficients of the energy value obtained by referring to the three dimensional location values, each of the energy values of the individual photon sensing arrays is multiplied by the corresponding correction coefficient so as to produce a number for the photon sensing array, and finally a sum of all four numbers of the four photon sensing arrays is formed and defined as the accurate energy for the gamma incidence event.

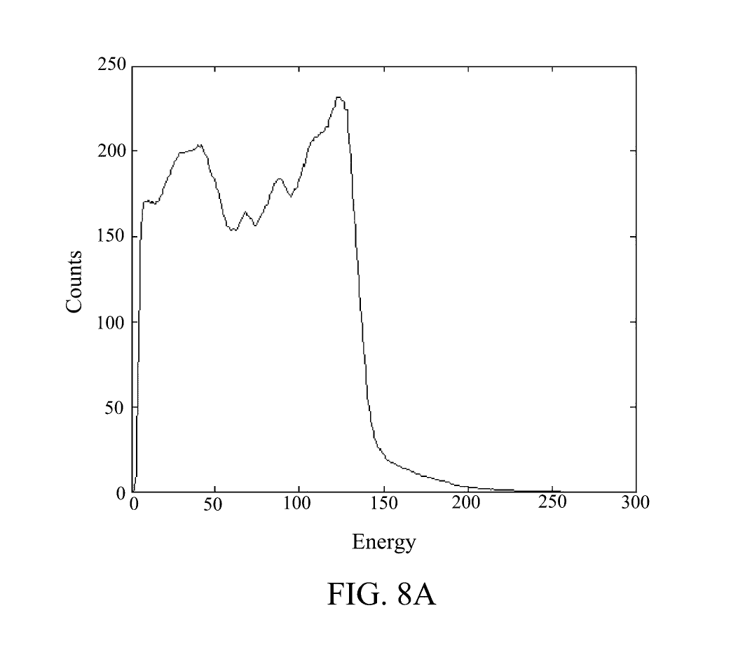

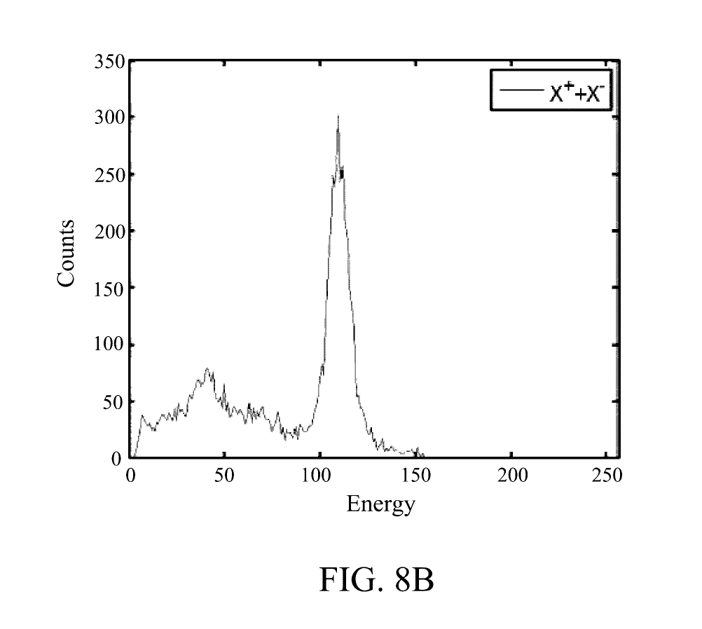

Referring now to FIG. 8A and FIG. 8B, two gamma energy spectra for corresponding testing samples in accordance with the present invention are illustrated. In a test with a 511-keV gamma ray radiation source exposure, compare the result without correction (FIG. 8A) and the result with correction (FIG. 8B). It is noted that the result with correction, which is contributed by applying the method of the present invention, can have the energy spectrum more concentrated and precise. Also, the post-correction energy spectrum is shown to be much resembled to the typical 511-keVgamma energy spectrum.

Thus, by having the three dimensional location values outputted in Step 23 and the corrected energy values outputted in Step 25, data for precisely computing the imaging is now enough.

In summary, the device for determining three dimensional locations and energy of gamma incidence events in accordance with the present invention is to divide the detecting crystal arrays into two types of the layers laminated in an interlacing manner. Namely, the detecting crystal arrays are arranged in a laminating way by alternatively interlacing the two types of the detecting crystal arrays, and any two types of the detecting crystal arrays belonging to the same layer are light-conductive to each other, but a light-spaced pattern is placed in the contact surface between layers. In the device of the present invention, four photon sensing arrays are mounted to four lateral sides of the detecting crystal, respectively, so as to have each the photon sensing array able to generate corresponding weight signals upon an incidence event. Provided with the aforesaid device and the aforesaid method for determining three dimensional locations and energy of gamma incidence events in accordance with the present invention, the calculation for locations and energy upon every gamma incidence events can be thus performed.

In addition, the present method further provides a screening process to determine valid events from a large amount of incidence events and to discard invalid events for reducing computational load. The location values derived from the valid events can be used for calculating the energy correction values. By providing the present invention, a simpler and more accurate method can be implemented to obtain three dimensional location values and further to obtain the energy correction coefficients according to the location values, such that more accurate or closer gamma energy values can be obtained. The three dimensional locations and the more accurate energy values can be implemented in the following processes to perform image-calculation and thereby to obtain quality PET/SPECT scan images.

While the present invention has been particularly shown and described with reference to a preferred embodiment, it will be understood by those skilled in the art that various changes in form and detail may be without departing from the spirit and scope of the present invention.

What is claimed is:

1. A method for determining three dimensional locations and energy of gamma incidence events, comprising the steps of:
(1) providing a multi edge-read imaging probe;
(2) the multi edge-read imaging probe detecting scintillating photons generated by a gamma incidence event, and thus obtaining a plurality of reaction locations corresponding to the scintillating photons;
(3) by referring to crystal look-up tables which are determined in a correction process, three dimensional locations respective to the plurality of reaction locations of the gamma incidence event being obtained;
(4) performing a process for screening a valid event, comparing location values of the plurality of reaction locations, the gamma incidence event being defined as a valid event and three dimensional location values being confirmed if the comparing of the location values is coherent;
(5) performing an energy-correction process upon the valid event, obtaining correction coefficients of energy values respective to the photon sensing arrays by comparing the energy-correction coefficient tables determined by the correction process and according to the three dimensional location values of the valid event; and
(6) performing a process of energy calculation, multiplying and summing the energy values with the respective correction coefficients for the corresponding photon sensing arrays of the valid event so as to obtain a total energy value for the gamma incidence event.

2. The method for determining three dimensional locations and energy of gamma incidence events of claim 1, prior to the step (1), further including the steps of:
(a) having a uniform emitting source to expose the multi edge-read imaging probe so as to accumulate a large amount of data of the gamma incidence events, recording a plurality of weight signals from each of the gamma incidence events; and
(b) obtaining a corresponding weighting center by calculating four of the weight signals of each of the photon sensing arrays for each of the gamma incidence events so as further to obtain a corresponding reaction location respective to each of the photon sensing arrays.

3. The method for determining three dimensional locations and energy of gamma incidence events of claim 2, after the step (b), further including the steps of:
(c) based on the photon sensing arrays, forming corresponding histograms from the reaction locations of the gamma incidence events so as to establish corresponding crystal maps to the individual photon sensing arrays; and
(d) analyzing individually the crystal maps so as to establish corresponding crystal look-up tables with respect to the individual photon sensing arrays.

4. The method for determining three dimensional locations and energy of gamma incidence events of claim 3, after the step (d), further including the steps of:
(e) basing on the crystal look-up tables of the corresponding photon sensing arrays to obtain location codes of the individual gamma incidence events;
(f) screening valid events; and
(g) based on the three dimensional location values, further classified the four energy values for each of the photon sensing arrays of each of the valid events by the photon sensing arrays, accumulating the energy values to obtain four energy spectrums of each of the location values corresponding to the individual photon sensing arrays.

5. The method for determining three dimensional locations and energy of gamma incidence events of claim 4, after the step (g), further including the steps of:
(h) analyzing the four energy spectrums of each of the location values to obtain photo-peak channels corresponding to the individual energy spectrums, further having the location values as entries for four photo-peak tables corresponding to the four photon sensing arrays;
(i) selecting basic correction values of energy individually from the corresponding photo-peak tables; and
(j) obtaining energy-correction coefficient tables for the corresponding photon sensing arrays.

6. The method for determining three dimensional locations and energy of gamma incidence events of claim 1, further including a step of performing a pre-correction process upon the multi edge-read imaging probe.

7. A device for determining three dimensional locations and energy of gamma incidence events, comprising:
at least one multi edge-read imaging probe, each of the at least one multi edge-read imaging probe having a plurality of multi edge-read imaging detectors, each of the multi edge-read imaging detectors further having:
a detecting crystal array, including a plurality of detecting crystal layers, each of the detecting crystal layers having a first-row detecting crystal and a second-row detecting crystal, the first-row detecting crystal being arranged perpendicular to the second-row detecting crystal, the first-row detecting crystals being individually isolated in a light-spaced pattern, the second-row detecting crystals being individually isolated in a light-spaced pattern, contact surfaces between the first-row detecting crystals and the neighboring second-row detecting crystals being light-conductive; and
a plurality of photon sensing arrays arranged individually to four lateral sides of the detecting crystal array, respectively, so as to detect the scintillating photons reaction inside the detecting crystal array; wherein, based on a plurality of reaction locations of each of the photon sensing arrays and compared with crystal look-up tables of the corresponding photon sensing arrays, location values with respect to the individual photon sensing arrays are obtained; wherein a screen process is performed to determine valid events and corresponding three dimensional location values; wherein the location values are used to obtain correction coefficients of energy values with respect to the individual photon sensing arrays; wherein accurate energy of the gamma incidence event is calculated by multiplying and summing the correction coefficients and the energy values of the individual photon sensing arrays.

8. The device for determining three dimensional locations and energy of gamma incidence events of claim 7, wherein the detecting crystal layers are isolated from each other.

9. The device for determining three dimensional locations and energy of gamma incidence events of claim 7, wherein the detecting crystal of the detecting crystal array is made of a solid-state scintillating material.

10. The device for determining three dimensional locations and energy of gamma incidence events of claim 7, wherein the photon-detecting array is selected from the group of a PMT array, a PSPMT detector/array, a PS-SiPM detector/array, a PSAPD detector/array and an SiPM array.
